(19) United States
(12) Patent Application Publication
(10) Pub. No.: US 2026/0192867 A1
(43) Pub. Date: Jul. 9, 2026

(54) Three types of self-driven rack guide modules

(71) Applicant: Xinfang Zhang, Shanxi (CN)

(72) Inventor: Xinfang Zhang, Shanxi (CN)

(21) Appl. No.: 19/009,186

(22) Filed: Jan. 3, 2025

(51) Int. Cl. B62D 33/08; B60R 5/00

(52) U.S. Cl. CPC B62D 33/08; B60R 5/003

(57) ABSTRACT

This application pertains to three types of rack-and-rail modules with integrated drives and their use in vehicle slide-out systems. The three types of rack-and-rail modules-skew, intersecting, and parallel-each include a module box, worm gear assembly or bevel gear assembly or spur gear assembly, motor, sliders, and a combined load-bearing rack. This application enables high-load and high-precision linear synchronous motion with an integrated drive. The rack-and-rail modules are applied in a vehicle slide-out system that includes, a rack-and-rail skew, intersecting, or parallel module with an integrated drive, a support frame, a load-bearing box, a slide-out. This system facilitates the extension and retraction of the vehicle's slide-out, thereby increasing interior space within the vehicle. The design ensures easy installation and removal while maintaining an aesthetically pleasing appearance.

### TECHNICAL FIELD

The present invention relates to three types of self-driven rack guide modules and their application in vehicle slide-out systems, which falls within the field of mechanical motion and vehicle space expansion technology.

### BACKGROUND OF THE INVENTION

Existing mechanical transmissions and modules require external drives to operate and move. DE102019A131278A1 discloses a rack and pinion guide transmission module that requires an external drive to move, occupying significant space and making installation inconvenient.

US202117A408020A discloses a vehicle slide-out device set on both sides of the slide-out box, but due to the complexity of the mechanism used, the telescopic drive device occupies a large amount of space, is inconvenient for maintenance, and increases the cost of use.

In response to these technical defects in the related technologies mentioned above, the inventor believes that existing mechanical transmissions and modules all require an external drive source to be provided, and when they are applied to vehicle slide-out systems, the slide-out mechanisms tend to be bulky, resulting in complex installation and occupying a lot of space.

### SUMMARY OF THE INVENTION

To address the issues of complex installation and large space occupation in mechanical transmission modules and vehicle slide-out systems, this invention provides the design of three types of self-driven rack guide modules and their application in vehicle slide-out systems. The three types of self-driven rack guide modules are, skew module, intersecting module, and parallel module. These modules come with their own drives, occupy small volume, and are easy to install. Simply connecting it to an electricity source allows the screw motion to be converted into the linear motion of the rack guide, achieving high-precision linear motion even under high loads.

### DETAILED DESCRIPTION OF THE PREFERRED EMBODIMENTS

To achieve the above objectives, the present invention adopts the following technical solutions,

Optionally, a self-driven rack guide skew module includes a module box, a worm gear assembly, a drive box, a gear box, a motor, slider one, slider two, slider three, slider four, guide rail one, guide rail two, and a combined load-bearing rack. The module box houses the drive box and the gear box. The drive box contains the motor, while the gear box houses the worm gear assembly. Guide rail one is equipped with guide hole one, and guide rail two is equipped with mounting hole two. The vertical plate of the combined load-bearing rack has guide fixing holes that correspond to guide hole one and mounting hole two, which are used to secure guide rail one and guide rail two on either side of the vertical plate of the combined load-bearing rack. At the bottom of the combined load-bearing rack, there is a rack. Slider one and slider two are slidably connected to guide rail one, while slider three and slider four are fixed and slidably connected to guide rail two. Slider one and slider two are attached to one side of the module box, and slider three and slider four are attached to the opposite side of the module box.

With the above technical solutions, the drive box and gear box are integrated into the module box. With its own drive source, the rack can be energized to perform high load and high precision linear motion on the slider. Thus, the linear synchronous reciprocating linear motion of the rack with its own drive can be realized. Easy installation and disassembly, overall aesthetic.

Optionally, the drive box and gear box are separated by a partition on which an output shaft bore is set.

With the above technology, the motor can be driven by the worm gear assembly through the output shaft bore.

Optionally, the worm gear assembly consists of an output shaft, worm gears, output gear, two snap rings, four bearings. The worm gears and the output gear are fixed on the output shaft. The snap ring one fixes the output gear, the snap ring two fixes worm wheel, the two sides of the output shaft are set with the bearing one and the bearing two, the bearing three and the bearing four is fixed on both ends of cylindrical worm, the output shaft of the motor is connected to the worm gears through the output shaft bore, the axis of cylindrical worm and the worm wheel is nonparallel and nonintersecting. The output gear engages with the rack to turn the spiral motion into a linear motion.

By using the above technology, the motor's output shaft is connected to a worm gear through an output shaft bore, drives worm gears for shifting and deceleration, worm wheel synchronous drive output gear rotation, output gear and rack mesh. The output gear transforms the spiral motion into a straight-line motion of the rack. Bearing one and bearing two support the output shaft, reducing the friction of the output shaft during the motion. Bearing three and bearing four support worms, reduce the friction of worm in the motion.

Optional, the module box is set with three bearing covers, the bearing cover one and the bearing one in conjunction with the Bearing Bore. The bearing cover two and the bearing two are arranged at the Bearing Bore two. The bearing cover three and the bearing three fit set in the Bearing Bore three places.

By adopting the above technical scheme, bearing cover one and bearing one with the corresponding bearing cover two and bearing two to provide support to the output shaft, it's easy for installation and maintenance. Bearing cover three and bearing three provide support for cylindrical worm, bearing four provide support for cylindrical worm and motor, convenient for installation.

Optionally, there is a grease fitting at the outside end of the gear box.

By adopting the aforementioned technical solution, the grease fitting provides lubrication to the gears, thereby reducing friction.

Optionally, a removable heat radiation lid is set on the side of the module box near the drive box. This motor heat sink cover has a wiring hole for powering the motor.

By adopting the aforementioned technical solution, the electrical wires of the motor can pass through the wiring hole to supply power to the motor. During the operation of the motor, the heat generated can dissipate via the heat radiation lid. Additionally, since the heat radiation lid is removable, it facilitates maintenance and installation.

In another embodiment, a self-driven rack and guide rail intersecting module comprises a module box, a bevel gear assembly, a drive box, a gear box, four sliders, two guide rails, and a combined load-bearing rack. Unlike the aforementioned skew module, this design uses a bevel gear assembly instead of a worm gear assembly.

The bevel gear assembly includes an input bevel gear, three output shafts, output bevel gear, another five gears, six bearings, six snap rings.

On output shaft one, there are the output bevel gear and gear two, with bearings five and six at both ends; snap ring three secures the output bevel gear, and snap ring four secures gear two.

On output shaft two, there are gear three and gear four, with bearings seven and eight at both ends; snap ring five secures gear three, and snap ring six secures gear four.

On output shaft three, there are gear five and gear six, with bearings nine and ten at both ends; snap ring seven secures gear five, and snap ring eight secures gear six.

The module box is equipped with six bearing covers, along with six Bearing Bores. Bearings, bearing covers and Bearing Bores are set correspondingly.

The motor's output shaft connects to the input bevel gear through the output shaft bore on partition. The input bevel gear meshes with the output bevel gear, changing direction by 90 degrees and reducing speed. Gear two meshes with gear three, and gear four meshes with gear five, while gear six meshes with the rack.

By adopting the above technical solution, the motor is powered via wiring hole. The motor's output shaft drives the input bevel gear inside the gear box through output shaft bore, turning 90 degrees and reducing speed. The input bevel gear meshes with the output bevel gear, driving it to rotate. As the output bevel gear and gear two are fixed on output shaft one, they rotate synchronously. Gear two drives gear three to rotate, and since gears three and four are fixed on output shaft two, they also rotate synchronously. Gear four meshes with gear five, which drives the gear six fixed on output shaft three to rotate. Gear six meshes with the rack, converting rotary motion into linear motion of the rack.

In another embodiment, a self-driven rack and guide rail parallel module includes a module box, a spur gear assembly, a drive box, a gear box, four sliders, two guide rails, and a combined load-bearing rack. Unlike the aforementioned self-driven rack and guide rail intersecting module, this design features an L-shaped gear box, with the drive box separated from the gear box by an L-shaped partition. The spur gear assembly replaces the bevel gear assembly, where the motor gear meshes in parallel with gear one. The output shaft is connected with motor gear through a output shaft bore on partition of the module box. In contrast to the bevel gear assembly, where the motor transfers motion through an input bevel gear meshing with an output bevel gear at a 90-degree angle, converting rotary motion into linear motion, the self-driven rack and guide rail parallel module achieves this conversion directly via the parallel motor gear meshing in parallel with gear one.

By adopting the above technical solution, the motor is powered via wiring hole. The motor gear on the motor's output shaft drives gear one inside the gear box through output shaft bore, with the gears meshing in parallel. The gear one drives output shaft one to rotate, which in turn drives gear two. Gear two meshes with gear three, which then drives gear four fixed on output shaft two to rotate. Gear four meshes with gear five, which drives gear six fixed on output shaft three to rotate. Gear six meshes with the rack, directly converting rotary motion into linear motion of the rack.

Optionally, the guide rail one, the guide rail two, and the combined load-bearing rack maintain a cantilever configuration when these three modules slide out and retract; the top of the combined load-bearing rack is equipped with connection holes. Depending on different application scenarios, the objects to be carried in those scenarios can be connected to the combined load-bearing rack through these connection holes.

By adopting the aforementioned technical solution, the cantilever design of the guide rail one, the guide rail two, and the combined load-bearing rack can increase the extension length without requiring additional support within a certain range. Depending on different application scenarios, the rack guide modules can be arranged in a skew, intersecting, or parallel manner and secured to various scenario-specific load-bearing objects.

Optionally, a vehicle slide-out system with an integrated drive includes a rack-and-rail module with an integrated drive arranged in a skew, intersecting, or parallel modules, along with a support frame, a load-bearing box, and a slide-out. The aforementioned rack-and-rail module with an integrated drive is installed inside the load-bearing box. The bottom of the module box for the rack-and-rail module with an integrated drive has connection holes that fix it to the top plate of the support frame. The support frame comprises a top plate, a bottom plate, and a vertical plate. The combined load-bearing rack is fixedly connected to the top inside of the load-bearing box. The rack-and-rail modules with an integrated drive are set parallel to the load-bearing box under the corresponding sides of the slide out and move synchronously. When the vehicle is stationary, the slide out can fully extend from the opening in the vehicle body, thereby increasing the usable space inside the vehicle. After retraction, the slide out aligns flush with the exterior of the vehicle, preserving its aesthetic appearance.

The technical solution adopted fixes the rack to the top inside of the load-bearing box, with the module box secured to the support frame. The rack drives the movement of the load-bearing box through a long slot opening, allowing for extension and retraction. The rack-and-rail modules with an integrated drive can bear significant loads while achieving precise linear motion. These modules are compactly integrated within the load-bearing box, minimizing space occupation and enhancing interior usable area and aesthetics. Additionally, the load-bearing box isolates the rack-and-rail modules from external contact, facilitating sealing and extending service life. Moreover, the bottom plate supports the entire slide out without requiring disassembly of the vehicle chassis; the bottom plate of the support frame is simply fixed to the vehicle body, suspending the slide out over the vehicle's opening and transferring its weight to the vehicle body.

In summary, this application provides at least the following beneficial technical effects,
1. Three types of rack-and-rail modules with integrated drives have their power units built into the module box, eliminating the need for external drive sources. Once powered, the motor's forward and reverse rotation moves the rack-and-rail through gears, enabling compact installation and easy maintenance.
2. The three types of rack-and-rail modules with integrated drives can withstand certain torques and achieve high-precision linear motion under heavy loads.
3. A vehicle slide-out system with an integrated drive ensures that the load-bearing box shields the rack-and-rail modules from external factors, offering neatness, beauty, and increased internal vehicle space.
4. A vehicle slide-out system with an integrated drive allows for convenient installation and removal without the need to dismantle the vehicle's lower chassis, as the entire slide out can be positioned at the vehicle's opening by merely fixing the support frame's bottom plate to the vehicle body.

### BRIEF DESCRIPTION OF THE DRAWINGS

To clearly illustrate the technical solutions of this invention, the following provides a simple introduction to the drawings used in the description. It should be understood that the drawings described below are merely some embodiments of this invention. Based on these drawings, those skilled in the art can obtain other drawings without making creative efforts.

FIGS. 1, 1A shows a perspective view from below of the skew module in a specific embodiment of this invention. 1B shows a perspective view from above of the same module mentioned in 1A.

FIG. 2 is a structural diagram of the skew module in a specific embodiment of this invention.

FIG. 3 is a structural diagram inside the module box showing the drive box and gear box of the skew module in a specific embodiment of this invention.

FIG. 4 is a sectional view of the structure of the skew module according to a specific embodiment of this invention.

FIG. 5 is an exploded view of the overall structure of the skew module according to a specific embodiment of this invention.

FIG. 6, in which 6A shows an illustration of the skew module before extended, according to a specific embodiment of this invention. 6B shows an illustration of the middle process of being extended for the module described in 6A. 6C shows an illustration of the fully extended state of the module described in 6A.

FIG. 7, in which 7A shows an illustration of the fully extended state of the skew module according to a specific embodiment of this invention. 7B shows an illustration of the middle process of retraction for the module described in 7A. 7C shows an illustration of the fully retracted state of the module described in 7A.

FIG. 8 is a structural diagram of the intersecting module according to a specific embodiment of this invention.

FIG. 9 is a sectional view of the structure of the intersecting module according to a specific embodiment of this invention.

FIG. 10 is an exploded view of the overall structure of the intersecting module according to a specific embodiment of this invention.

FIG. 11 is a structural diagram of the parallel module according to a specific embodiment of this invention.

FIG. 12 is a sectional view of the structure of the parallel module according to a specific embodiment of this invention.

FIG. 13 is an exploded view of the overall structure of the parallel module according to a specific embodiment of this invention.

FIG. 14, in which 14A shows a structural diagram of the load-bearing box in the vehicle slide-out system with an integrated drive rack-and-rail module according to a specific embodiment of this invention. 14B shows a schematic diagram of the rack-and-rail module with an integrated drive according to a specific embodiment of this invention. 14C shows a structural diagram of the support frame in the vehicle slide-out system with an integrated drive rack-and-rail module according to a specific embodiment of this invention.

FIG. 15, in which 15A shows a sectional view of the slide-out after it has been extended according to a specific embodiment of this invention. 15B shows a sectional view of the slide-out after it has been retracted according to a specific embodiment of this invention.

FIG. 16, in which 16A shows an illustration of the slide-out system with a skew, intersecting, or parallel module before extended according to a specific embodiment of this invention. 16B shows an illustration of the fully extended state of the slide-out system with a skew, intersecting, or parallel module according to a specific embodiment of this invention. 16C shows an oblique view of the completely extended slide-out in the vehicle equipped with a skew, intersecting, or parallel module according to a specific embodiment of this invention.

FIG. 17, in which 17A shows an illustration of the fully extended state of the slide-out system with a skew, intersecting, or parallel module according to a specific embodiment of this invention. 17B shows an illustration of the fully retracted state of the slide-out system with a skew, intersecting, or parallel module according to a specific embodiment of this invention. 17C shows an oblique view of the completely retracted slide-out in the vehicle equipped with a skew, intersecting, or parallel module according to a specific embodiment of this invention.

### BRIEF DESCRIPTION OF THE FIGURES

Follow are the reference numbers appear in the drawings,
1. Module box
2a. Slider One; 2b. Slider Two; 2c. Slider Three; 2d. Slider Four
3a. Guide Rail One; 3b. Guide Rail Two
301. Mounting Hole one; 302. Mounting Hole Two
4A. Partition in Embodiment 1, 4B Partition in Embodiment 2; 4C. Partition in Embodiment 3
5. Motor
6. Output Shaft in Embodiment 1; 601A. Snap Ring One; 601B Snap Ring Two
7A. Heat Radiation Lid; 701. Wiring Hole
8. Cylindrical Worm
9. Worm Wheel
10. Output Gear in Embodiment 1
12A. Bearing Cover One; 12B. Bearing Cover Two; 12C. Bearing Cover Three; 12D. Bearing Cover Seven; 12E. Bearing Cover Eight; 12F. Bearing Cover Nine; 12G. Bearing Cover Four; 12H. Bearing Cover Five; 12J. Bearing Cover Six
14A. Bearing One; 14B. Bearing Two; 14C. Bearing Three; 14D. Bearing Four
16. Grease Fitting
17A. Drive box in Embodiment 1; 17B. Drive box in Embodiment 2; 17C. Drive box in Embodiment 3
18A. Gear box in Embodiment 1; 18B. Gear box in Embodiment 2; 18C. Gear box in Embodiment 3
19A. Output Shaft Bore in Embodiment 1; 19B. Output Shaft Bore in Embodiment 2; 19C. Output Shaft Bore in Embodiment 3
20. Connection Holes for Combined Load-Bearing Rack
21. Module box Baseplate Connection Holes
23. Skew Module
24. Intersecting Module; 240. Input Bevel Gear; 243A. Output Shaft One; 243B. Output Shaft Two; 243C. Output Shaft Three; 244A. Output Bevel Gear; 244B. Gear Two; 244C. Gear Three; 244D. Gear Four; 244E. Gear Five; 244F. Gear Six; 247A Bearing Five; 247B. Bearing Six; 247C. Bearing Seven; 247D. Bearing Eight; 247E. Bearing Nine; 247F. Bearing Ten; 249A. Snap Ring Three; 249B. Snap Ring Four; 249C. Snap Ring Five; 249D. Snap Ring Six; 249E. Snap Ring Seven; 249F. Snap Ring Eight
25. Parallel Module; 250. Motor Gear in Embodiment 3; 254A. Gear One in Embodiment 3
26. Support Frame; 261. Top Plate; 262. Bottom Plate; 263. Vertical Plate
27. Load-Bearing Box; 271. Cover Plate; 273. Fixing Holes on Load-Bearing Box
28. Long Slot Opening
29. slide-out
30. Vehicle Body
31. Worm Gear Assembly
32. Bevel Gear Assembly
33. Spur Gear Assembly
35. Rack
36A. Bearing Bore One; 36B. Bearing Bore Two; 36C. Bearing Bore Three; 36G. Bearing Bore Four; 36H. Bearing Bore Five; 36J. Bearing Bore Six; 36D. Bearing Bore Seven; 36E. Bearing Bore Eight; 36F. Bearing Bore Nine
38. Combined Load-Bearing Rack
39. Fixing Holes for Guide Rail

### DETAILED DESCRIPTION OF THE INVENTION

To make the objectives, features, and advantages of this invention more apparent and understandable, the following describes the technical solutions of the invention in detail with reference to the accompanying drawings of the specific embodiments. It is evident that the embodiments described below are only part of the embodiments of this invention and not all of them. Based on the embodiments of this patent, all other embodiments obtained by those skilled in the art without making any inventive effort fall within the scope of protection of this patent.

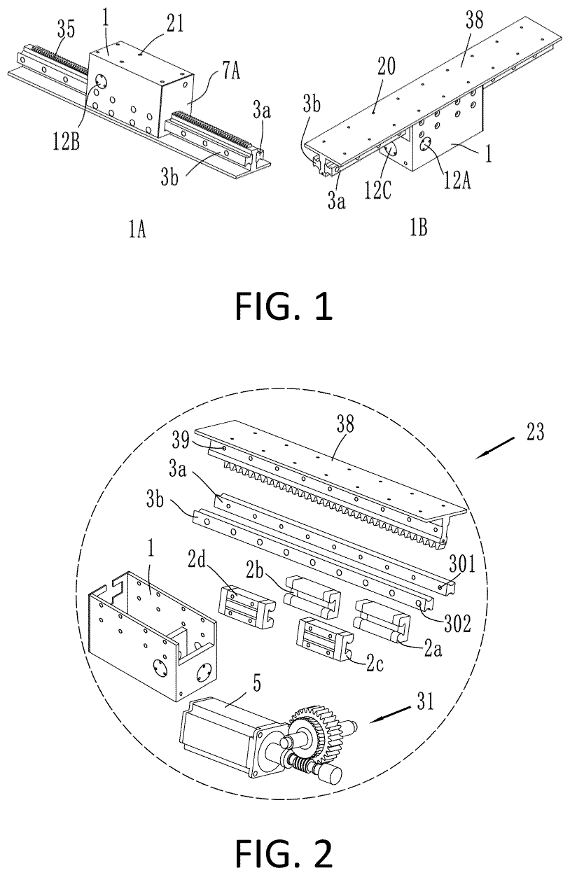

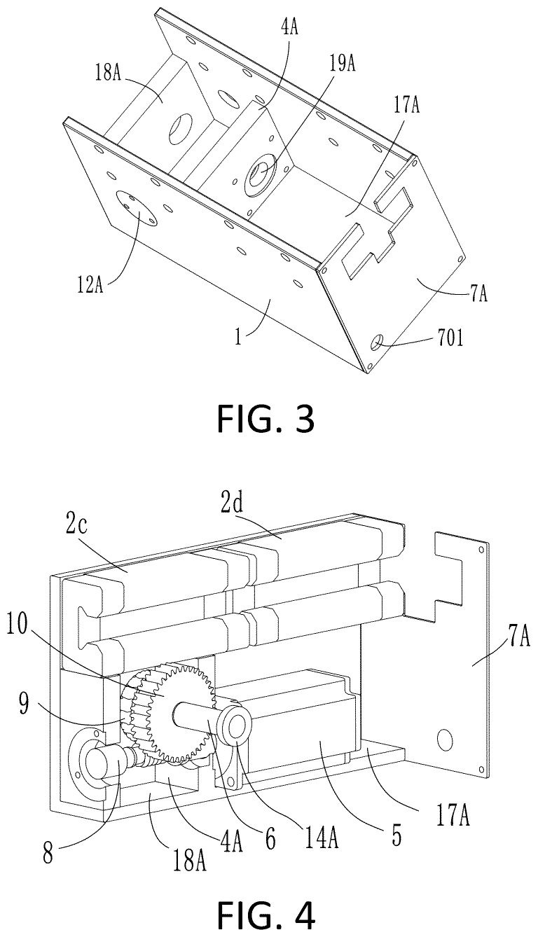

Embodiment 1, referring to FIGS. 1, 2, and 3, a self-driven skew module 23 includes a module box 1, a worm gear assembly 31, a drive box 17A, a gear box 18A, a motor 5, sliders one 2a, sliders two 2b, sliders three 2c, and sliders four 2d, guide rail one 3a, guide rail two 3b, and a combined load-bearing rack 38. Inside the module box 1, there are the drive box 17A and the gear box 18A, which are separated by partition 4A, which has an output shaft bore 19A. The drive box 17A houses the motor 5, while the gear box 18A houses the worm gear assembly 31. The motor 5 drives the worm gear assembly 31 through output shaft bore 19A. Guide rail one 3a features mounting hole one 301, and guide rail two 3b features mounting hole two 302. The vertical plate of the combined load-bearing rack 38 has corresponding fixing holes 39 that align with mounting hole one 301 and two 302 to fix guide rails one 3a and two 3b on either side of the vertical plate. The bottom of the combined load-bearing rack 38 is equipped with a rack 35. Sliders one 2a and two 2b are slidingly connected to guide rail one 3a, while sliders three 2c and four 2d are fixedly connected to guide rail two 3b. Sliders one 2a and two 2b are attached to one side of the module box 1, and sliders three 2c and four 2d are attached to the opposite side.

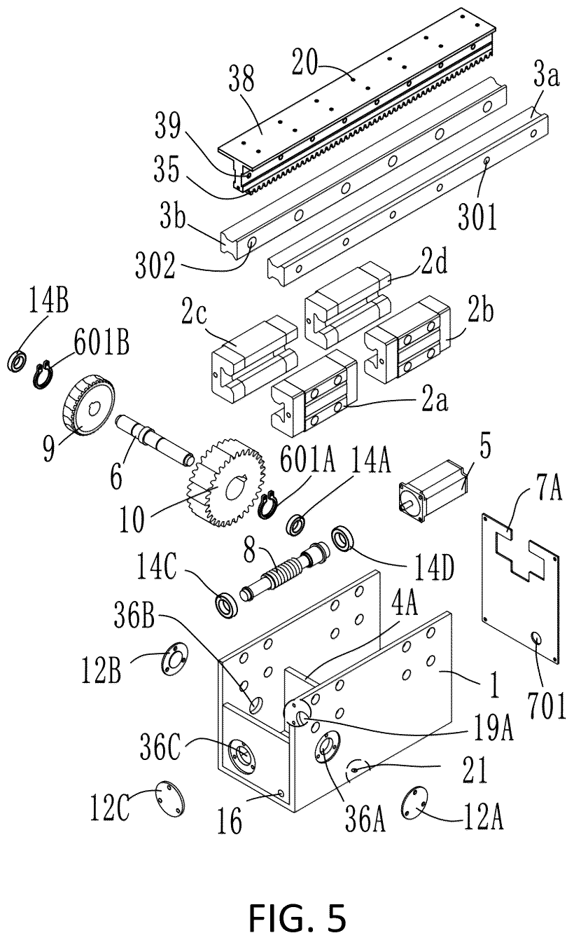

Referring to FIGS. 4 and 5, the worm gear assembly 31 comprises an output shaft 6, a cylindrical worm 8, a worm wheel 9, output gear 10, snap ring one 601A, and snap ring two 601B, as well as bearings one 14A, two 14B, three 14C, and four 14D. The output shaft 6 is fitted with the worm wheel 9 and the output gear 10, secured by snap ring one 601A for the output gear 10 and snap ring two 601B for the worm wheel 9. Bearings one 14A and two 14B are placed on both sides of the output shaft 6, while bearings three 14C and four 14D support the cylindrical worm 8. The module box 1 includes bearing covers one 12A, two 12B, and three 12C, along with bearing bore one 36A, two 36B, and three 36C. Bearing cover one 12A and bearing one 14A are fitted into bearing bore one 36A; bearing cover two 12B and bearing two 14B into bearing bore two 36B; and bearing cover three 12C and bearing three 14C into bearing bore three 36C. The motor 5 output shaft connects to the cylindrical worm 8 through output shaft bore 19A. The cylindrical worm 8 engages with the worm wheel 9, and the output gear 10 meshes with the rack 35, converting rotational motion into linear motion of the rack 35.

Additionally, a removable motor heat radiation lid 7A is installed on the side of the module box 1 near the drive box 17A, facilitating motor cooling and maintenance. The motor heat radiation lid 7A has a wiring hole 701 for power supply. A grease fitting 16 is provided on the exterior of the gear box 18A for lubrication.

The top of the combined load-bearing rack 38 has connection holes 20 for attaching application-specific loads. The bottom of the module box 1 has connection holes 21 for securing it to a support structure.

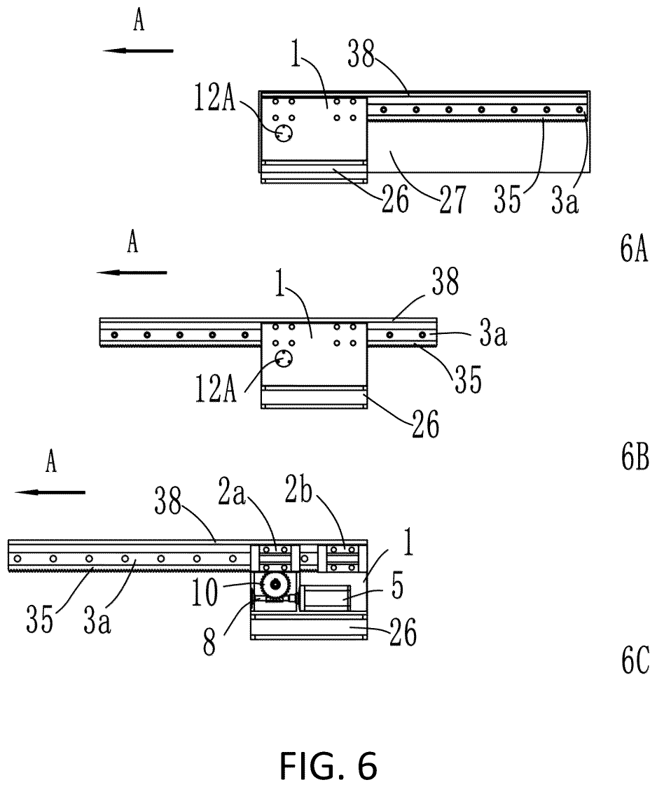

Referring to FIG. 6, powering the motor 5 causes its output shaft to drive the cylindrical worm 8 through output shaft bore 19A, which in turn drives the worm wheel 9 and synchronously rotates the output gear 10. This gear meshing with the rack 35 converts rotational motion into linear motion, causing the combined load-bearing rack 38 to slide out. FIG. 6A shows the retracted state, 6B the partially extended state, and 6C the fully extended state, with the extension direction indicated by arrow A.

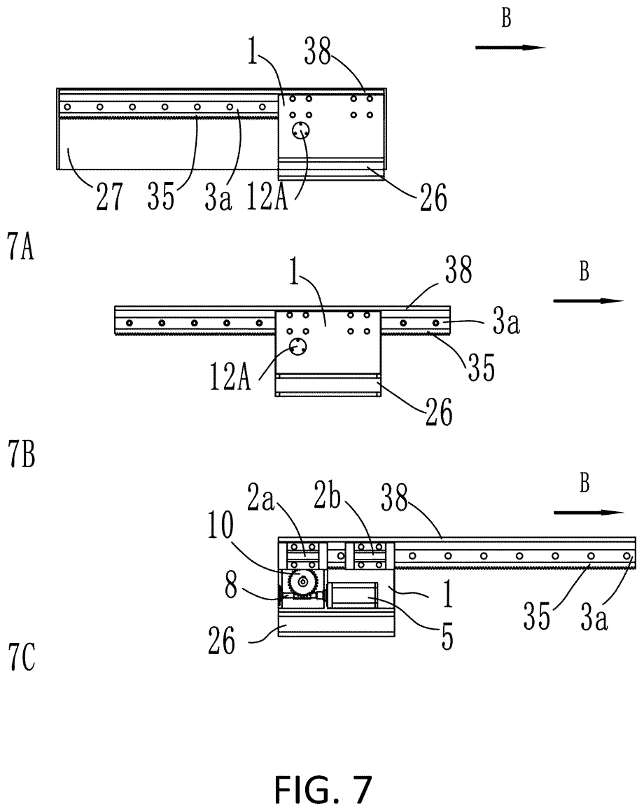

Referring to FIG. 7, reversing the motor 5 drives the cylindrical worm 8 in the opposite direction, leading to the retraction of the combined load-bearing rack 38. FIG. 7A shows the fully extended state, 7B the partially retracted state, and 7C the fully retracted state, with the retraction direction indicated by arrow B.

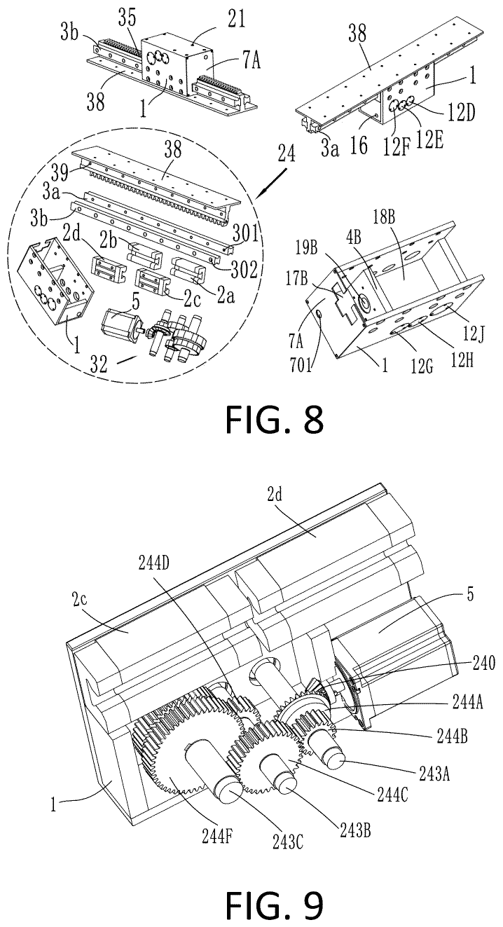

Embodiment 2, Referring to FIG. 8, a self-driven intersecting module 24 includes a module box 1, a bevel gear assembly 32, a drive box 17B, a gear box 18B, sliders one 2a, two 2b, three 2c, and four 2d, guide rail one 3a, guide rail two 3b, and a combined load-bearing rack 38. Unlike the skew module 23, this module uses a bevel gear assembly 32 instead of a worm gear assembly 31.

Referring to FIG. 9, the motor 5 output shaft connects to an input bevel gear 240 through output shaft bore 19B on partition 4B. The input bevel gear 240 intersects with and engages an output bevel gear 244A, which changes the direction of rotation by 90 degrees and reduces speed. The output bevel gear 244A drives output shaft one 243A, which then drives gear two 244B. Gear two 244B meshes with gear three 244C, which drives gear four 244D mounted on output shaft two 243B. Gear four 244D meshes with gear five 244E, which drives gear six 244F mounted on output shaft three 243C. Gear six 244F meshes with the rack 35, converting rotational motion into linear motion.

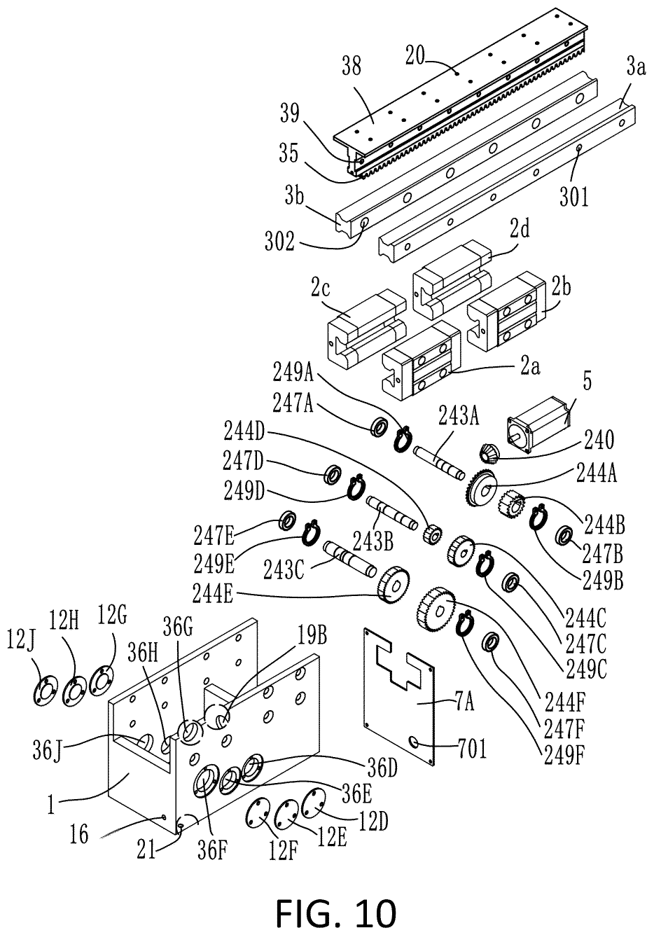

Referring to FIG. 10, the bevel gear assembly 32 includes input bevel gear 240, output shafts one 243A, two 243B, and three 243C, output bevel gear 244A, gears two 244B, three 244C, four 244D, five 244E, six 244F, bearings five 247A through ten 247F, and snap rings three 249A through eight 249F. Output shaft one 243A features output bevel gear 244A and gear two 244B, supported at both ends by bearings five 247A and six 247B, with snap ring three 249A securing output bevel gear 244A and snap ring four 249B securing gear two 244B. Similarly, output shaft two 243B and three 243C have respective gears and bearings, secured by snap rings.

In this embodiment, the module box 1 includes bearing covers four 12G through nine 12F, and bearing bores four 36G through nine 36F. Bearings and their corresponding covers are fitted into these holes.

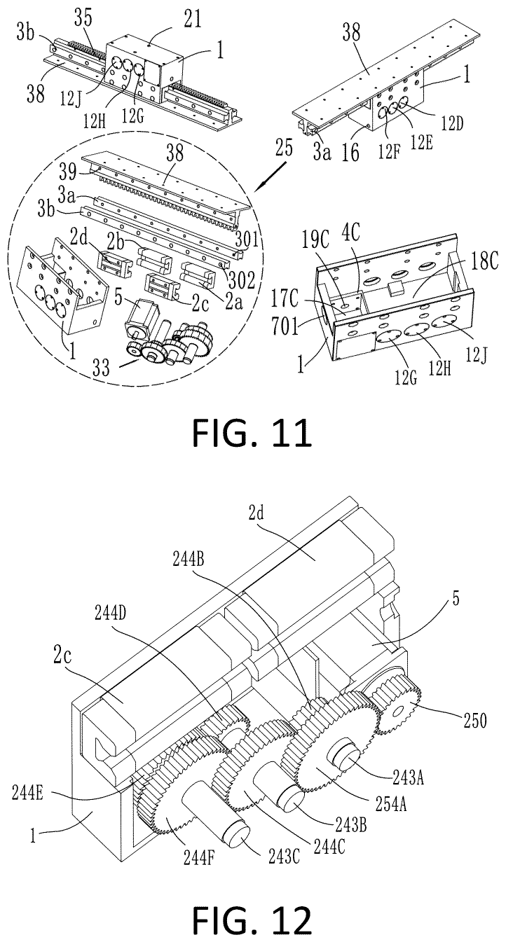

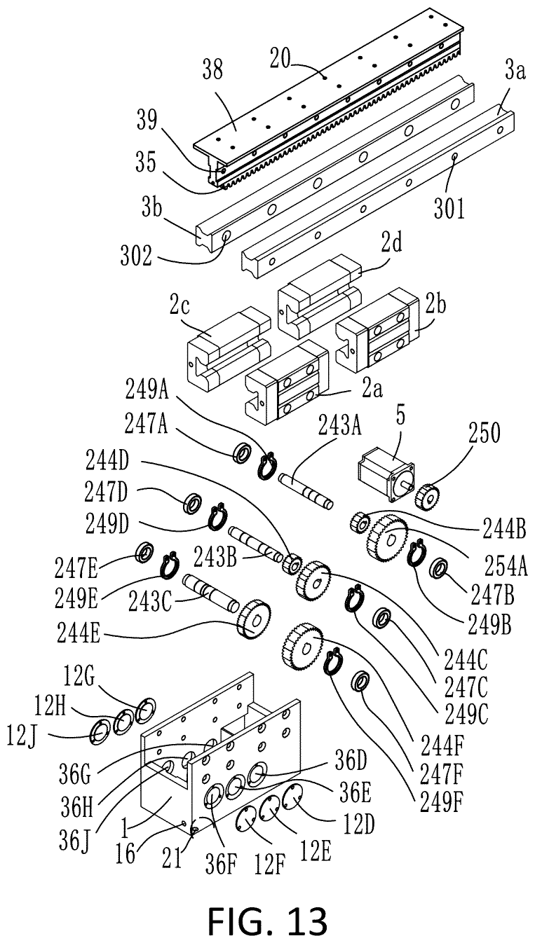

Embodiment 3, referring to FIGS. 11, 12, and 13, a self-driven parallel module 25 includes a module box 1, a spur gear assembly 33, a drive box 17C, a gear box 18C, sliders one 2a, two 2b, three 2c, and four 2d, guide rail one 3a, guide rail two 3b, and a combined load-bearing rack 38. Unlike the intersecting module 24, the gear box 18C is L-shaped and separated from the drive box 17C by L-shaped partition 4C. It uses a spur gear assembly 33 instead of a bevel gear assembly 32. The spur gear assembly 33 differs in that the motor gear 250 meshes in parallel with gear one 254A, directly converting rotational motion into linear motion. The motor 5 output shaft connects to the motor gear 250 through output shaft bore 19C on partition 4C.

Referring to FIG. 12, wires pass through wiring hole 701 to power the motor 5, driving the motor gear 250, which meshes with gear one 254A. The gear one 254A drives output shaft one 243A, which then drives gear two 244B. Gear two 244B meshes with gear three 244C, which drives gear four 244D on output shaft two 243B. Gear four 244D meshes with gear five 244E, which drives gear six 244F on output shaft three 243C. Gear six 244F meshes with the rack 35, converting rotational motion into linear motion.

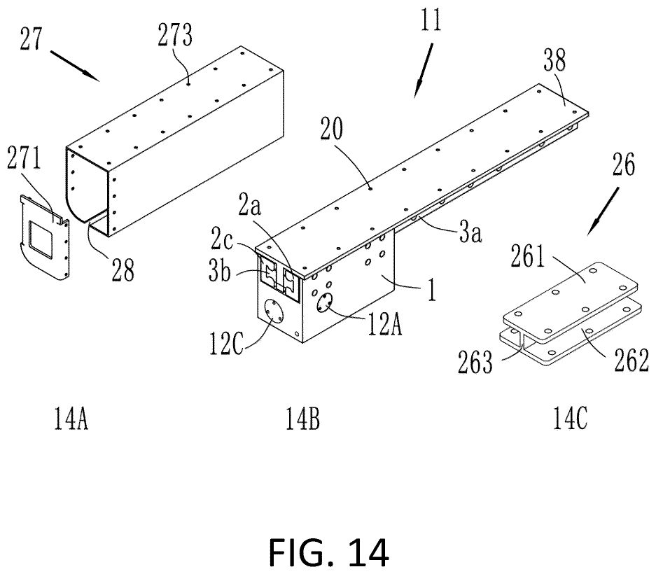

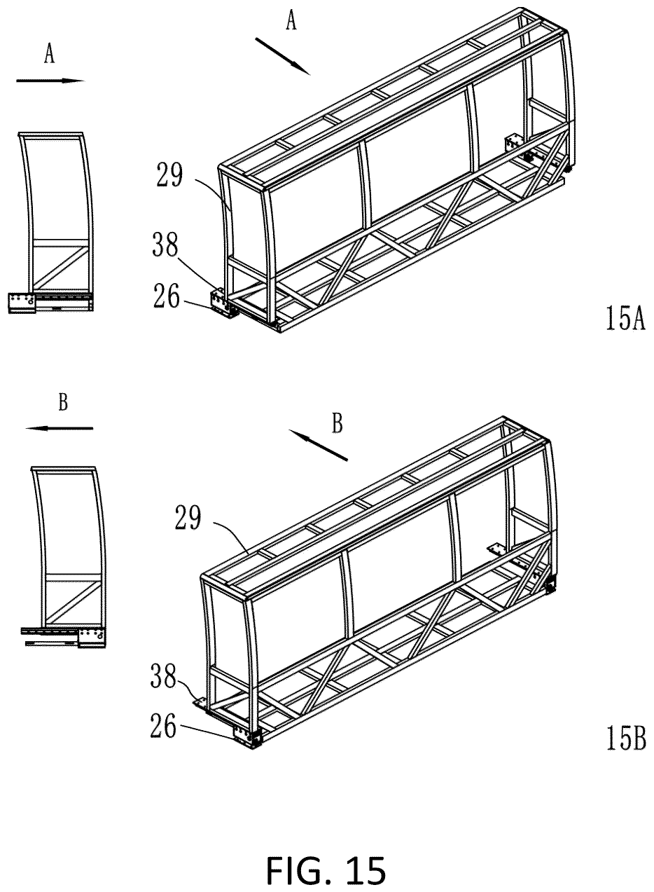

Referring to FIGS. 14 and 15, a vehicle slide-out system with an integrated drive rack-and-rail module includes a module 23, 24, or 25, a support frame 26, a load-bearing box 27, and a slide-out 29. The load-bearing box 27 has a removable cover plate 271 on the side facing the inside of the vehicle, with fixing holes 273 on top and a long slot opening 28 at the bottom. The support frame 26 consists of a top plate 261, bottom plate 262, and vertical plates 263.

The integrated drive rack-and-rail module is set inside the load-bearing box 27 at the lower part of the slide-out 29 on both sides. The combined load-bearing rack 38 is fixed to the load-bearing box 27 via connection holes 20 corresponding to fixing holes 273. The module box 1 is secured to the top plate 261 of the support frame 26 using connection holes 21, and the bottom plate 262 is installed on the vehicle body 30. Two load-bearing boxes 27 are set parallel under the slide-out 29, with identical internal structures performing synchronized linear motion.

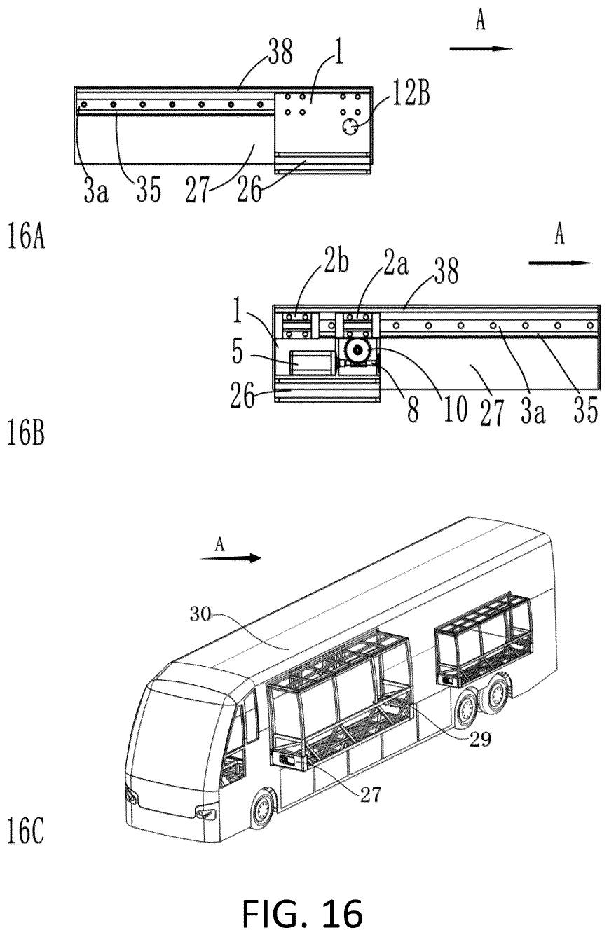

Referring to FIG. 16, in the sliding system, the slide-out 29 is mounted to the vehicle's opening via the support frame 26. When the motor 5 is powered to rotate forward, it drives the skew module 23, intersecting module 24, or parallel module 25, moving the rack 35 outward. The load-bearing box 27 slides out through the long slot opening 28 on both sides of the vertical plates 263, extending to a preset position, as shown by arrow A.

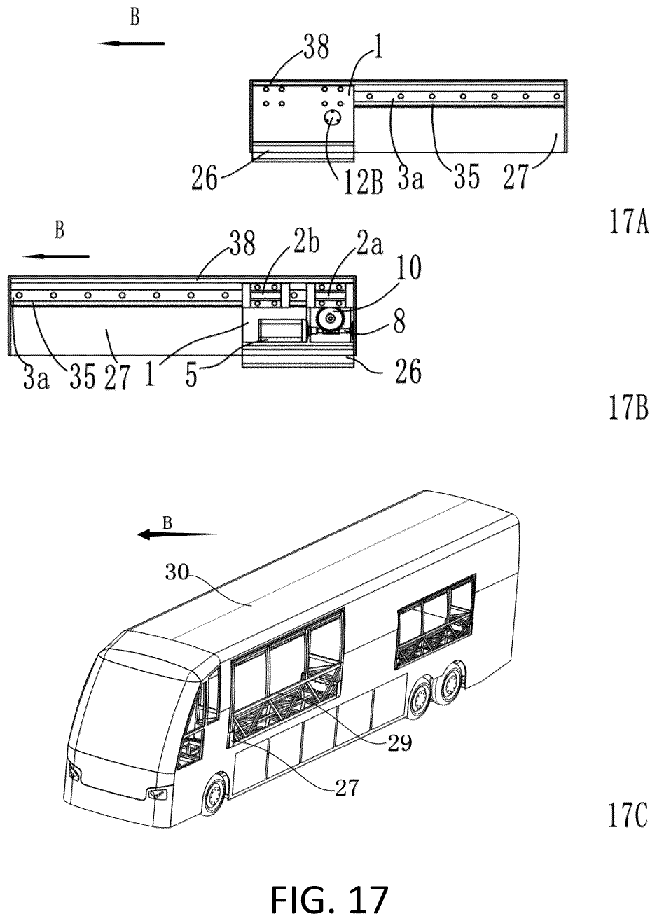

Referring to FIG. 17, when the motor 5 reverses, it drives the rack 35 inward, retracting the load-bearing box 27 back through the long slot opening 28 on both sides of the vertical plates 263. The slide-out 29 retracts until it is flush with the vehicle body 30, as shown by arrow B.

The above description of the disclosed embodiments enables those skilled in the art to implement or use this invention. Various modifications to these embodiments will be readily apparent to those skilled in the art, and the general principles defined herein may be applied to other embodiments without departing from the spirit or scope of the invention. Thus, this invention is not limited to the embodiments shown herein but is to be accorded the widest scope consistent with the principles and novel features disclosed herein.

1. A rack-and-rail skew module with an integrated drive, comprising: a module box, a worm gear assembly, a drive box, a gear box, a motor, sliders one, two, three, and four, guide rail one and guide rail two, a combined load-bearing rack. The module box houses the drive box and the gear box. The drive box contains the motor, while the gear box contains the worm gear assembly. Guide rail one features mounting hole one, and guide rail two features mounting hole two. The vertical plate of the combined load-bearing rack has corresponding guide fixing holes that align with mounting holes one and two to fix guide rails one and two on either side of the vertical plate. The bottom of the combined load-bearing rack is equipped with a rack. Sliders one and two are slidingly connected to guide rail one, while sliders three and four are fixedly connected to guide rail two. Sliders one and two are attached to one side of the module box, and sliders three and four are attached to the opposite side.

2. The rack-and-rail skew module with an integrated drive as claimed in claim 1, characterized in that the drive box and the gear box are separated by a partition, which has an output shaft bore.

3. The rack-and-rail skew module with an integrated drive as claimed in claim 2, characterized in that the worm gear assembly comprises: an output shaft, a cylindrical worm, a worm wheel, an output gear, snap ring one and snap ring two, bearings one, two, three, and four. The output shaft is fitted with the worm wheel and the output gear, secured by snap ring one for the output gear and snap ring two for the worm wheel. Bearings one and two support the output shaft, while bearings three and four support the cylindrical worm. The motor output shaft connects to the cylindrical worm through the output shaft bore, which engages with the worm wheel. The output gear meshes with the rack, converting rotational motion into linear motion.

4. The rack-and-rail skew module with an integrated drive as claimed in claim 3, characterized in that the module box includes bearing covers one, two, and three, along with bearing bore one, two, and three. Bearing cover one and bearing one are fitted into bearing bore one; bearing cover two and bearing two into bearing bore two; and bearing cover three and bearing three into bearing bore three.

5. The rack-and-rail skew module with an integrated drive as claimed in claim 4, characterized in that one end of the gear box exterior is equipped with a gear box grease fitting.

6. The rack-and-rail skew module with an integrated drive as claimed in claim 5, characterized in that a removable motor heat radiation lid is installed on the side of the module box near the drive box, with a wiring hole for power supply.

7. A rack-and-rail intersecting module with an integrated drive, comprising: a module box, a bevel gear assembly, a drive box, a gear box, sliders one, two, three, and four, guide rail one and guide rail two, a combined load-bearing rack. Unlike the rack-and-rail skew module with an integrated drive, this module uses a bevel gear assembly instead of a worm gear assembly. The bevel gear assembly includes: an input bevel gear, output shafts one, two, and three, an output bevel gear, gears two, three, four, five, six, bearings five through ten, snap rings three through eight. Output shaft one features output bevel gear and gear two, supported at both ends by bearings five and six, with snap ring three securing output bevel gear and snap ring four securing gear two. Similarly, output shafts two and three have respective gears and bearings, secured by snap rings. The module box includes bearing covers four through nine, and bearing bores four through nine. Bearings and their corresponding covers are fitted into these holes. The motor output shaft connects to the input bevel gear through output shaft bore on partition. The input bevel gear intersects with and engages the output bevel gear, changing the direction of rotation. Gears two and three mesh, as do gears four and five, and gears six mesh with the rack.

8. A rack-and-rail parallel module with an integrated drive, comprising: a module box, a spur gear assembly, a drive box, a gear box, sliders one, two, three, and four, guide rail one and guide rail two, a combined load-bearing rack. Unlike the intersecting module, the gear box is L-shaped and separated from the drive box by L-shaped partition. It uses a spur gear assembly instead of a bevel gear assembly. The spur gear assembly differs in that the parallel motor gear meshes in parallel with gear one, converting rotational motion directly into linear motion. The motor output shaft connects to the motor gear through output shaft bore on partition. The intersecting module features a motor that engages with the output bevel gear through an input bevel gear. This arrangement changes the direction of motion, converting rotational movement into linear movement.

9. The rack-and-rail (skew, intersecting, or parallel) module with an integrated drive as claimed in claims 1, 7, or 8, characterized in that guide rails one and two, and the combined load-bearing rack remain cantilever design during extension and retraction. The top of the combined load-bearing rack has connection holes for attaching application-specific loads.

10. A vehicle slide-out system with an integrated drive rack-and-rail module includes: a rack-and-rail (skew, intersecting, or parallel) module with an integrated drive, a support frame, a load-bearing box, a slide-out. The rack-and-rail module (skew, intersecting, or parallel) is set inside the load-bearing box. The bottom of the module box has connection holes for securing it to the top plate of the support frame. The support frame consists of a top plate, bottom plate, and vertical plates. The combined load-bearing rack is fixed to the top of the load-bearing box. The rack-and-rail module (skew, intersecting, or parallel) is positioned parallel at the lower part of the slide-out on both sides, performing synchronized motion. When the vehicle is stationary, the slide-out can extend fully from the vehicle body, increasing interior space. Upon retraction, the slide-out aligns flush with the vehicle body, maintaining aesthetic integrity.
